(19) United States
(12) Patent Application Publication
(10) Pub. No.: US 2013/0187819 A1
(43) Pub. Date: Jul. 25, 2013

(54) MAGNETIC SHEET AND PRODUCTION METHOD THEREOF, AS WELL AS ANTENNA APPARATUS USING SAME

(71) Applicant: PANASONIC CORPORATION, Osaka (JP)

(72) Inventors: Shinichi WAKASUGI, Miyazaki (JP); Koji Yasumura, Miyazaki (JP); Masatoshi Izaki, Miyazaki (JP)

(73) Assignee: PANASONIC CORPORATION, Osaka (JP)

(21) Appl. No.: 13/744,742

(22) Filed: Jan. 18, 2013

(30) Foreign Application Priority Data
Jan. 20, 2012 (JP) 2012-009884
Jan. 20, 2012 (JP) 2012-009885
Apr. 26, 2012 (JP) 2012-101106

(51) Int. Cl. H01F 7/00; B32B 3/26; H01F 41/00; H01Q 7/06

(52) U.S. Cl. CPC H01F 7/00; H01Q 7/06; B32B 3/266; H01F 41/00
USPC 343/787; 428/137; 428/134; 29/592

(57) ABSTRACT

A magnetic sheet that is omnidirectionally flexible, particularly one that is thin, reliably divided into small fragments and has flexibility, is fired in a planar shape. A magnetic sheet of the claimed invention includes: a magnetic body; a protective member provided on at least one face of the magnetic body; and a plurality of holes provided in at least one face of the magnetic body. The magnetic body is divided into a plurality of small fragments using the plurality of holes. The plurality of small fragments vary in shape.

### CROSS REFERENCE TO RELATED APPLICATIONS

This application is entitled to and claims the benefit of Japanese Patent Application No. 2012-009884, filed on Jan. 20, 2012, Japanese Patent Application No. 2012-009885, filed on Jan. 20, 2012, and Japanese Patent Application No. 2012-101106, filed on Apr. 26, 2012, the disclosures of which, including their specifications, drawings and abstracts, are incorporated herein by reference in their entirety.

### TECHNICAL FIELD

The claimed invention relates to a magnetic sheet used in antenna modules (of RFIDs and/or the like), wireless charging modules, and/or the like, and to a production method thereof, as well as to an antenna apparatus using same.

### BACKGROUND ART

Extremely thin magnetic sheets have conventionally been placed on the outer surface of electronic components to block the electromagnetic waves thereof. Such magnetic sheets are flexible because of their structure where they are divided into many small fragments of a particular size (Japanese Patent Application Laid-Open No, 2009-182062, hereinafter referred to as “D1”).

Furthermore, in D1, a ferrite sheet is held between a cover sheet and a double-sided adhesion sheet, the ferrite sheet having horizontally and vertically intersecting linear grooves formed in its surface. The above is bent to break all grooves, and a ferrite sheet composite is thus formed.

### SUMMARY OF INVENTION

### Technical Problem

However, because the ferrite sheet disclosed in D1 is flexible only in the vertical and horizontal directions in which the grooves are formed, it lacks flexibility in all other directions, e.g., in oblique directions.

Furthermore, there is currently a demand for thinner ferrite sheets. By way of example, with ferrite sheets that are approximately 300 μm in thickness, it becomes particularly difficult to form grooves. Specifically, should the grooves lack depth even slightly, users would be unable to break the ferrite sheets favorably at the grooves. On the other hand, even a slight deepening of the grooves would cause the grooves to divide the ferrite sheets before firing, thus making it impossible to fire a ferrite sheet in a planar shape. In other words, due to the thinness of the ferrite sheets, the tolerable range of groove thickness is limited, with no room even for slight variability in groove depth. Consequently, it has conventionally been difficult to favorably break (divide) grooves in their entirety due to slight variability in groove depth.

### Solution to Problem

The claimed invention provides a magnetic sheet that is flexible in directions other than the vertical and horizontal directions, e.g., in an oblique direction, and that is thus made easy to use, as well as an antenna apparatus using same. More particularly, the claimed invention provides a magnetic sheet that can be fired in a planar shape even in cases where a magnetic sheet that has been made thin is reliably divided into small fragments to be made flexible, as well as an antenna apparatus using same.

With respect to the above, the claimed invention includes a magnetic sheet including: a magnetic body; a protective member provided on at least one face of the magnetic body; and a plurality of holes provided in at least one face of the magnetic body. The magnetic body is divided into a plurality of small fragments using the plurality of holes, and the plurality of small fragments have varying shapes.

### ADVANTAGEOUS EFFECTS OF INVENTION

With the claimed invention, it is possible to provide flexibility in directions besides the vertical and horizontal directions, e.g., in an oblique direction, thereby providing a magnetic sheet that is easy to use. Furthermore, it is possible to fire a magnetic sheet in a planar shape even in cases where the magnetic sheet is thin and is reliably divided into small fragments to be made flexible.

### BRIEF DESCRIPTION OF DRAWINGS

FIG. 1 is a diagram showing a magnetic sheet with respect to the present embodiment;

FIGS. 2A and 2B are schematic diagrams showing a magnetic sheet with respect to the present embodiment;

FIGS. 3A and 3B are enlarged views of a key portion of a magnetic sheet with respect to the present embodiment before being divided into small fragments;

FIGS. 4A and 4B are enlarged views of a key portion of a magnetic sheet with respect to the present embodiment after being divided into small fragments;

FIG. 5 is an enlarged sectional view of holes with respect to the present embodiment;

FIG. 6 is a production process flow diagram for a magnetic sheet with respect to the present embodiment;

FIGS. 7A and 7B are diagrams showing a method of forming a plurality of holes with respect to the present embodiment;

FIG. 8 is a diagram showing the effects of recessed end sections at the edges of a magnetic body with respect to the present embodiment;

FIG. 9 is a diagram showing the periphery of recessed end sections at the edges of various magnetic bodies with respect to the present embodiment;

FIGS. 10A through 10E are diagrams each showing an alternative shape for the recessed end sections at the edges of a magnetic body with respect to the present embodiment; and

FIG. 11 is a configuration diagram of an antenna apparatus with respect to the present embodiment.

### DESCRIPTION OF EMBODIMENTS

### Embodiment

Magnetic sheets with respect to an embodiment of the claimed invention, as well as antenna apparatuses using same, are described below with reference to the drawings.

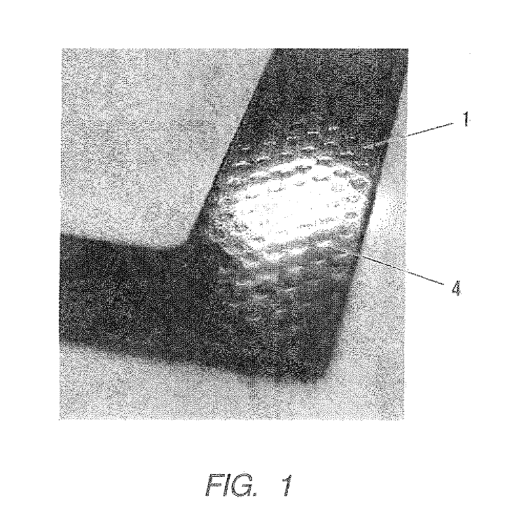

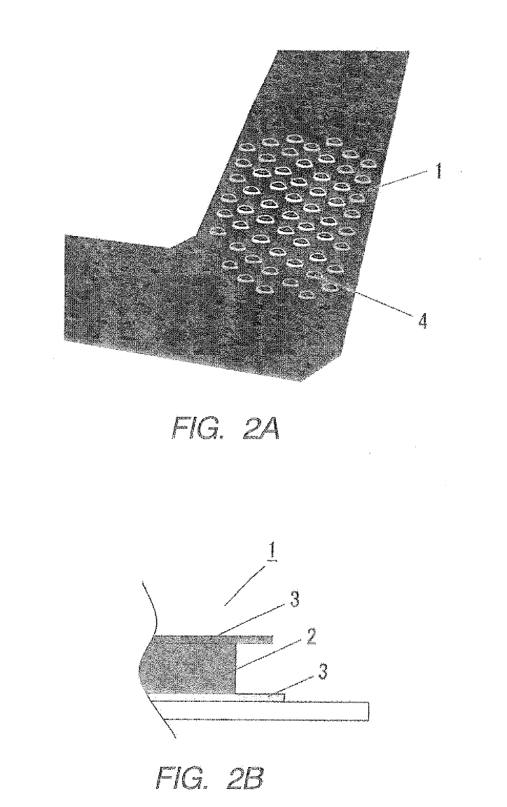

FIG. 1 is a diagram showing a magnetic sheet with respect to the present embodiment, and is a photograph of the surface of magnetic sheet 1. FIGS. 2A and 2B are schematic diagrams showing a magnetic sheet with respect to the present embodiment, FIG. 2A is a diagram showing the surface of a magnetic sheet, and FIG. 2B is a sectional view of the magnetic sheet.

Magnetic sheet 1 includes: magnetic body 2; protective member 3 provided on at least one face of magnetic body 2; and a plurality of holes 4 provided in at least one face of magnetic body 2. Magnetic body 2 is divided using the plurality of holes 4. In other words, among the plurality of holes 4, magnetic body 2 is divided at least between each hole and the hole closest thereto, for example.

Magnetic body 2 may be, for example, a ferrite sintered body. Examples of ferrites include Mn—Zn-based ferrites, Ni—Zn-based ferrites, Mg—Zn-based ferrites, and/or the like. Magnetic body 2 may be, for example, a magnetic body such as an amorphous metal, permalloy, electrical steel, silicon steel, an Fe—Al alloy, or a sendust alloy. Furthermore, for magnetic body 2, a magnetic material may be incorporated into a sheet-shaped resin material. Magnetic body 2 is sheet-shaped. Magnetic body 2 may be 50 μm to 300 μm in thickness, and is 100 μm in thickness in the present embodiment.

Protective member 3 is flexible and may include, for example, a plastic such as polyethylene terephthalate (PET). Protective member 3 maintains magnetic body 2, which is divided into small fragments, in a sheet shape, and prevents magnetic body 2 from changing its shape so that the small fragments of magnetic body 2 would not drop off or break. Protective member 3 may be provided on both the upper and lower faces of magnetic sheet 1, and protects at least one face of magnetic sheet 1. It is preferable that protective member 3 be insulative. Protective member 3 may also be, for example, an adhesive, an adhesive sheet, and/or the like, for causing an FPC including an antenna pattern, and/or the like, and sheet-shaped magnetic body 2 to adhere to each other.

The plurality of holes 4 are formed in at least one of the upper and lower faces of magnetic body 2. Holes 4 may be through-holes, but are preferably recessed sections each having a bottom. Holes 4 will be described in detail hereinafter.

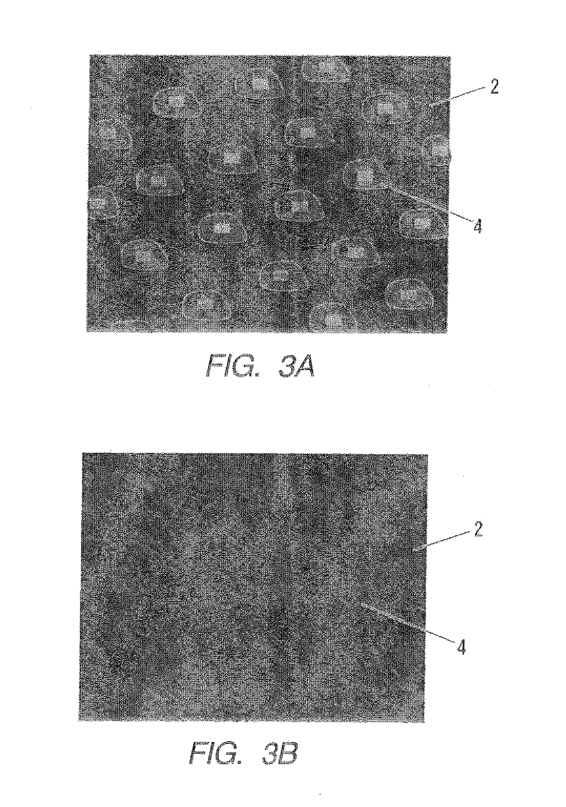

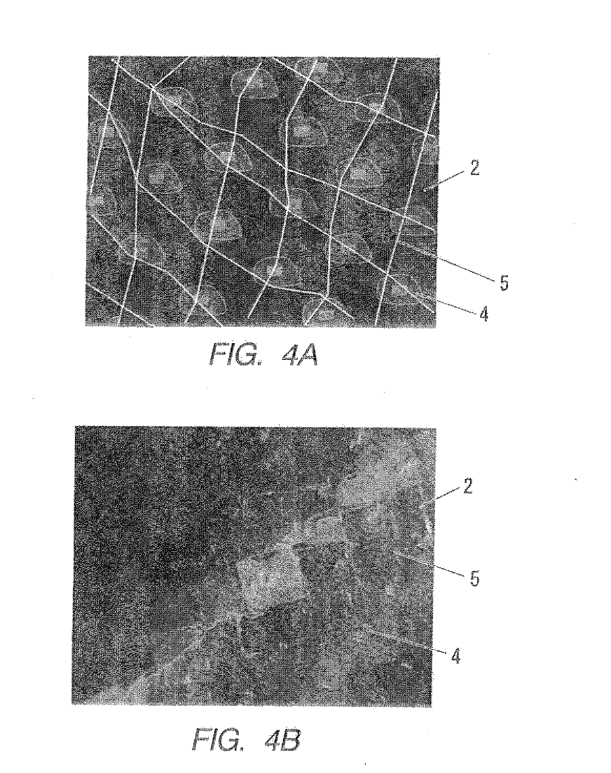

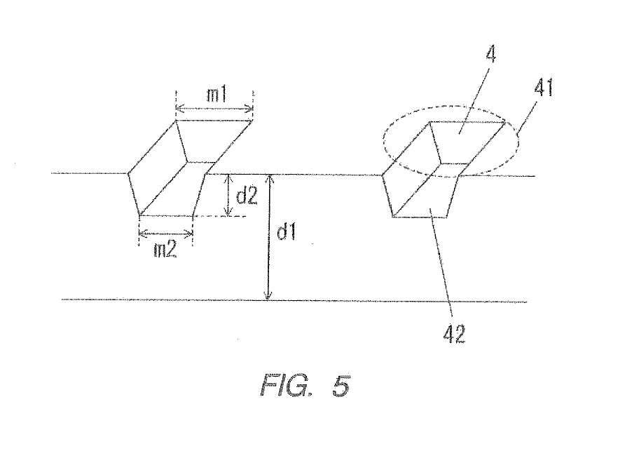

FIGS. 3A and 3B are enlarged views of a key portion of a magnetic sheet before being divided into small fragments with respect to the present embodiment. FIGS. 4A and 4B are enlarged views of a key portion of a magnetic sheet after being divided into small fragments with respect to the present embodiment. FIG. 5 is an enlarged sectional view of holes with respect to the present embodiment. FIGS. 3A and 4A are schematic representations, while FIGS. 3B and 413 are photographs thereof, respectively.

With respect to these diagrams, the plurality of holes are configured as follows.

(1) The shortest inter-hole distance between holes 4 is 1 mm, although it may vary from 0.5 mm to 3 mm. However, the shortest inter-hole distance between holes 4 also varies depending on the thickness of sheet-shaped magnetic body 2, and is by no means limited to the above. In the present embodiment, four holes 4 are adjacent to each hole 4 by the shortest distance. By providing three or more holes 4 that are adjacent by the shortest distance, it is easier to form a magnetic sheet that is flexible in all directions. In other words, by having holes 4 each be adjacent to a plurality of holes 4 (particularly three or more) by the shortest distance, it is possible to prevent flexibility from being greater in one direction than in another direction, thereby causing flexibility to vary depending on the direction. In other words, the directions of the division lines of magnetic sheet 1 are not strictly anticipated. The division lines of magnetic sheet 1 have at least a given level of uniformity. Magnetic sheet 1 might be divided in all directions, or in a plurality of directions. Accordingly, the plurality of division lines are sometimes not mutually parallel or perpendicular.

(2) The plurality of holes 4 are arranged in a rhomboid grid. However, so long as the plurality of holes 4 are provided at certain intervals, the arrangement of the plurality of holes 4 is not limited to any particular shape. However, it is preferable that the arrangement of the plurality of holes 4 be uniform across the entire surface of magnetic sheet 1 (the sheet face of magnetic body 2). In addition, it is preferable that the arrangement of the plurality of holes 4 be an arrangement that has a certain level of regularity as in a triangular pattern, a polygonal pattern, a geometric pattern, a grid, and/or the like. This enables the formation of uniform division lines 5.

(3) As shown in FIG. 5, holes 4 are tapered in such a manner that the opening is greater in area than the bottom section. Opening 41 is generally rectangular and measures 0.35 mm×0.2 mm. Bottom section 42 of hole 4 is generally rectangular and measures 0.21 mm×0.1 mm (in FIG. 5, m1:m2=0.2:0.1). Furthermore, the area of the opening of hole 4 may be approximately two to five times, preferably three to four times, the area of the bottom of hole 4. This makes it possible to form flatter magnetic sheets 1. Specifically, when the area of the opening and the area of the bottom section are the same, the periphery of hole 4 becomes susceptible to rising during the formation of hole 4, which makes it difficult to form magnetic sheet 1 in a flat manner.

(4) Depth d2 of holes 4 is approximately 10% of thickness d1 (approximately 100 μm) of the magnetic sheet (i.e., d2 is approximately 10 μm), a preferable range thereof being 5% to 30%. If holes 4 are too shallow, it becomes difficult to divide magnetic sheet 1 using holes 4. If holes 4 are too deep, on the other hand, magnetic body 2 in the periphery of each hole 4 rises during the formation of holes 4, making it difficult to form magnetic sheet 1 in a flat manner. However, if it is possible to remove magnetic body 2 where it has risen in the periphery of the opening of each hole 4, depth d2 of holes 4 may exceed 30%, even becoming a through hole without presenting any problems.

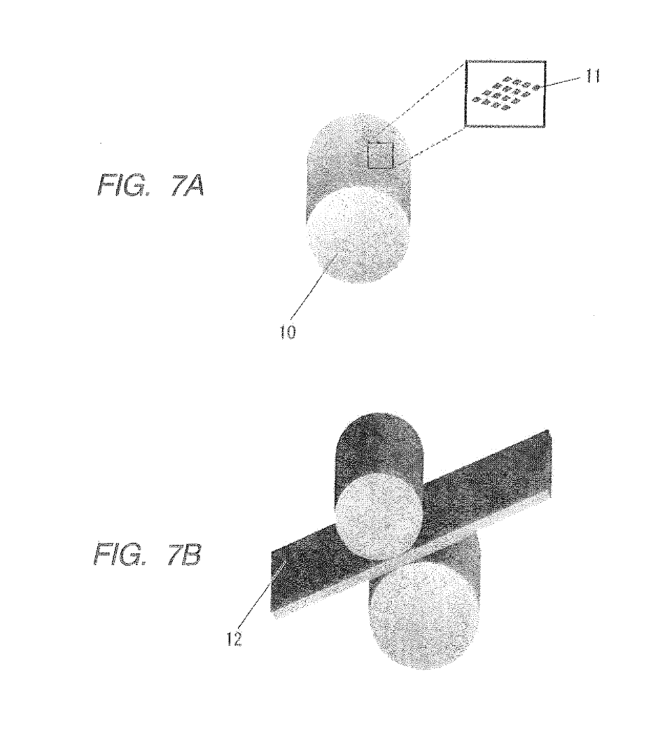

(5) For the shape of the bottoms of holes 4, a rectangular, rhombic, or polygonal shape is preferable. The shape of holes 4 is, for example, identical to the shape of protrusions on a roller for forming holes 4 (see FIG. 7A). A method for producing magnetic sheet 1 will be described hereinafter. By virtue of the fact that the bottoms of holes 4 are so shaped to have corners, it is made easier to divide magnetic sheet 1 using those corners.

(6) The proportion of the area occupied by the openings of holes 4 relative to the areas of the upper and lower faces of magnetic sheet 1 is 27%, but may range from 20% to 40%, approximately. The proportion of the area occupied by the bottoms of holes 4 relative to the areas of the upper and lower faces of magnetic sheet 1 is 8%, but may range from 5% to 15%, approximately.

(7) The openings and bottom sections of holes 4 are of generally the same shape (generally rectangular), but differ in size (i.e., they are similar). It is preferable that the openings and the bottom sections be concentric. Because this makes it easier for division lines 5 to pass through holes 4, by arranging holes 4 uniformly or with regularity, division lines 5 would also be formed uniformly and with regularity.

Magnetic sheet 1 is divided into small fragments using these holes 4. Division lines (slits) 5 are not necessarily linear, and may in some cases be bent or curved. Furthermore, division lines 5 are not necessarily parallel or perpendicular to one another, and may in some eases intersect randomly. As shown in FIGS. 1, 2A and 2B, when magnetic sheet 1 is rectangular, straight lines that, connect holes 4 that are closest to one another intersect with the perimeter (the four sides) of magnetic sheet 1.

A method of producing magnetic sheet 1 will now be described.

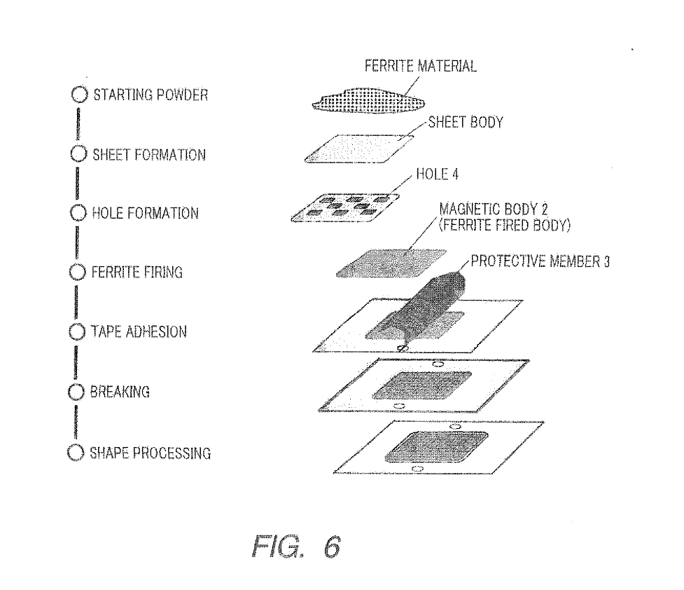

FIG. 6 is a production process flow diagram for a ferrite sheet with respect to the present embodiment. A production process flow is described below taking a ferrite sheet as an example of a magnetic sheet.

By way of example, ferric oxide Fe₂O₃, nickel oxide NiO, zinc oxide ZnO, and copper oxide CuO are mixed as starting materials over a predetermined period. The mixture slurry is dried at a temperature of 110° C. to 130° C., subsequently crushed, pre-fired at 800° C. to 910° C., and pulverized, thus producing a main component powder.

The ferrite magnetic material thus produced has an average particle size of 0.5 μm to 1.6 μm according to particle size distribution measurements by a laser diffraction scattering method. Furthermore, according to BET specific surface area measurements by a nitrogen gas adsorption method, it has a value of 3-7 m²/g.

A polyvinyl butyral resin, a phthalate ester plasticizer, and an organic solvent are mixed with 100 weight parts of the ferrite magnetic material thus produced, which is then mixed with a dedicated mill to produce a slurry. The viscosity of the thus produced slurry is 1500-2500 Pa·sec at 20° C., which is appropriate for sheet forming.

Next, the slurry including the ferrite magnetic material is formed into a film on a PET film to produce a green sheet that is 50 μm to 350 μm in thickness.

Next, the plurality of holes 4 are formed in this green sheet.

FIGS. 7A and 7B are diagrams showing a method of forming a plurality of holes with respect to the present embodiment.

As shown in FIG. 7A, roller 10, on which a plurality of protrusions 11 are arranged regularly, is rolled over green sheet 12 while being pressed as shown in FIG. 7B. Thus, the plurality of protrusions 11 dig into green sheet 12, thereby forming the plurality of holes 4 in green sheet 12.

Next, in a cutting step, green sheet 12 is cut into a predetermined shape. Specifically, green sheet 12 is punch cut using a dedicated die/tool designed to fit the shapes of spiral antennas for wireless charging modules, or for RFID or NFC communication, and a body having a predetermined shape and thickness is thus produced.

After placing a body (green sheet 12) having a predetermined shape in a saggar, degreasing and firing are carried out to produce a ferrite fired body, The ferrite fired body is 30 μm to 300 μm in thickness. The degreasing condition is 200° C. to 600° C. Next, a ferrite sintered body is fired at a maximum temperature of 1000° (a preferable range being 800° C. to 1200° C.) in a firing furnace to produce a final ferrite fired body.

Next, a protective member (a protective tape) is stuck on each of the upper and lower faces of this sheet-shaped ferrite fired body. By then applying pressure from at least one side of the protective member, the ferrite sheet is divided by means of holes 4. Pressure may be applied from either side of the ferrite sheet, i.e., from the upper face side or the lower face side. If division is to be carried out by forming linear grooves, pressure must be applied from the side that is not the side of the face in which the grooves are formed, thus making sure the sheet is folded inward at the groove portions. However, in the present embodiment where division is carried out using the plurality of holes 4, the ferrite sheet is similarly divisible regardless of whether pressure is applied from the side of the face in which holes 4 are formed, or from the other side. Holes 4 may be formed in both the upper and lower faces of the ferrite sheet, or in just one of the faces.

Dividing by means of holes 4 does not necessarily mean that division lines 5 would pass through holes 4, as shown in FIGS. 4A and 4B. However, it does make use of the fact that holes 4 are of at least some level of regularity. Since magnetic body 2 is thinner at holes 4 than it is at other parts, magnetic body 2 breaks more readily at and around holes 4. Consequently, division lines occur in such a manner as to connect holes 4 that are closest to one another. Accordingly, since magnetic body 2 is divided between the plurality of holes 4 which are arranged with uniform regularity, it is divided with generally uniform regularity. Consequently, the sizes of the small fragments will not vary significantly regardless of which part of magnetic body 2 they are located at. Division lines 5 may also be observed at places other than between holes 4 that are closest to one another.

Thus, magnetic body 2 can be divided with regularity by simply forming holes 4 and applying pressure. Accordingly, magnetic sheet 1 having flexibility can be obtained with extreme ease. In other words, in order to carry out division by forming grooves as in the related art example, linear grooves must be formed at uniform intervals and with a uniform depth, which leads to greater variability and is more time consuming. However, in the case of holes 4, even if their depths were to vary, magnetic sheet 1 would be readily divisible, and they may be formed deeper than the grooves formed in the related art example. Furthermore, unlike the grooves formed in the related art example, holes 4 can be formed in magnetic sheet 1 as if to stamp them, and they are thus extremely easy to form. Furthermore, while grooves have directionality in and of themselves, holes 4 do not. Thus, magnetic sheet 1 is able to exhibit flexibility in accordance with the direction in which it is bent.

Furthermore, so long as the depths of holes 4 are at least 5% of the thickness of magnetic body 2, magnetic body 2 can be formed in the shape of a flat sheet even if holes 4 are formed deeper than 5%, In other words, because the plurality of holes 4 are formed in such a manner as to be spaced apart from one another, even if holes 4 were through-holes, green sheet 12 would not fall apart during the formation of holes 4. Accordingly, provided that magnetic body 2 at parts where holes 4 are to be formed can be removed sufficiently, the depths of holes 4 may be 30% or greater.

Furthermore, because division lines 5 are introduced among holes 4 in magnetic sheet 1 by means of the plurality of holes 4, division lines 5 may be introduced in any direction. As such, flexibility is exhibited not only in the vertical and horizontal directions, but in any direction, such as in oblique directions.

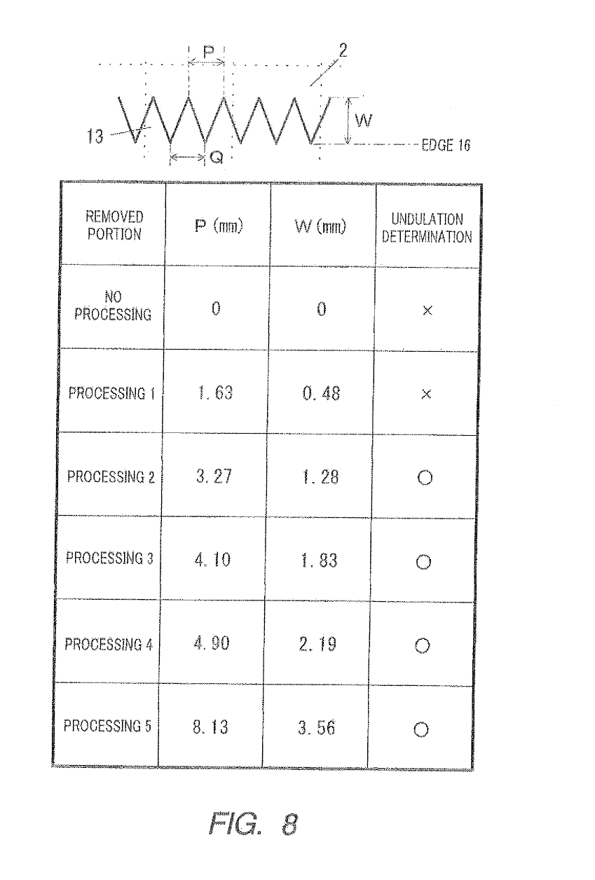

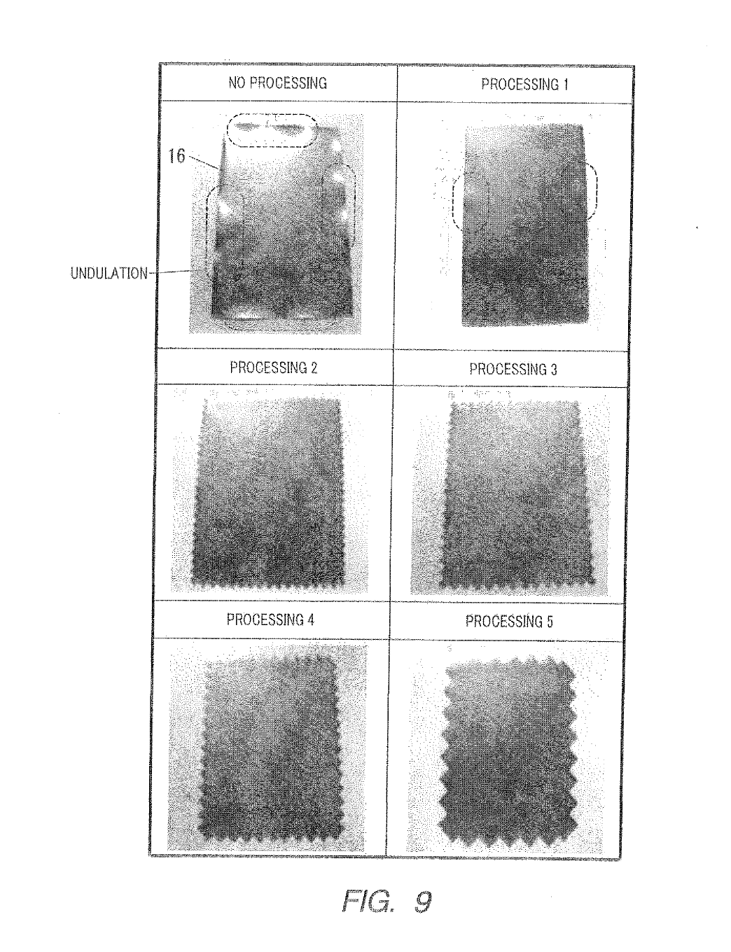

With respect to when green sheet 12 is punch cut using a dedicated die/tool, the shape of edges 16 (see FIG. 9) of magnetic body 2 thus punched out will now be described in detail with reference to FIGS. 8 and 9.

FIG. 8 is a diagram showing the effects of recessed end sections at the edges of a magnetic body with respect to the present embodiment. FIG. 9 shows diagrams of the periphery of recessed end sections at the edges of magnetic bodies with respect to the present embodiment, the diagrams being photographs of the sheet surfaces of magnetic bodies 2.

Magnetic sheet 1 with respect to the present embodiment is such that the end sections of the sheet faces (i.e., the planar front-face and back face) of magnetic sheet 1 include a plurality of recessed end sections 13 that recede inward of the sheet face from the end sections of the sheet face. The sheet face may be formed in various shapes, e.g., square, rectangular, polygonal, circular, elliptical, and/or the like. By way of example, the plurality of recessed end sections 13 may be formed by forming the following in a wave-like shape, serrated (jagged) shape, pulsed shape, and/or the like: the four sides if the end sections of the sheet face are, that is, if the sheet face is, square or rectangular; the respective sides if it/they is/are polygonal; or the perimeter if it/they is/are circular or elliptical.

There are demands for thinner ferrite sheets, which correspond to magnetic sheet 1. Accordingly, when firing such ferrite sheets, corrugation (worsened flatness) occurs more readily, particularly at the edges of the ferrite sheet. Furthermore, if the corrugated portions occurring at the edges of the ferrite sheet were to be removed, this would decrease the effectively usable area of the ferrite sheet, which is wasteful.

On the other hand, if the ferrite sheet were to be used with its worsened flatness left as is, it would not make for even contact with the coil surface to be mounted thereon, causing the gap between the coil and the ferrite sheet to vary. Consequently, there would also be a problem in that coil characteristics would worsen and vary depending on the location, rendering it impossible to sufficiently bring out the performance of the coil.

Accordingly, by adopting the configuration of magnetic sheet 1 described below, occurrences of undulation at the edges may be prevented with ease even if magnetic sheet 1 is thin. The size of magnetic sheet 1 may be used effectively, making magnetic sheet 1 easy to use. Magnetic sheet 1 and a coil may be placed in even contact with each other to make the gap between the coil and magnetic sheet 1 uniform, thereby providing favorable coil characteristics regardless of location.

In punch cutting green sheet 12, if it is cut in such a manner that P=W=0 mm (where P denotes the pitch of recessed end sections 13, and W the depth of recessed end sections 13), that is, if edges 16 are cut linearly (i.e., without any processing), and fired in a firing furnace, vertical undulation (warping) occurs near edges 16 of magnetic body 2 as shown in FIG. 9. By way of example, when the area of the sheet face of magnetic sheet 1 after firing is 50 mm×70 mm, this undulation occurs at a position that is 10 mm to 20 mm inward of edges 16 of magnetic body 2, with the height of the undulation being approximately 1.5 mm.

In particular, undulation occurs during firing more readily with thin film magnetic bodies 2 where the thickness of magnetic body 2 is 50 μm to 350 μm, and where the area of magnetic body 2 is 100 mm×100 mm or less.

The occurrence of undulation was next studied by varying the size of recessed end sections 13 formed at edges 16 of green sheet 12 prior to the firing of green sheet 12.

The combination of pitch P of recessed end sections 13 and depth W of recessed end sections 13 is varied as shown in FIG. 8. When there are no recessed end sections 13, undulation is observed in magnetic body 2, but as P and W are increased (that is, as the size of recessed end sections 13 is increased), undulation gradually stops occurring.

This is because, when ferrite firing is performed by heating, at a high temperature, magnetic body 2 that has been cut from green sheet 12, various parts of magnetic body 2 expand and contract at different rates due to the high-temperature heating. Accordingly, when edges 16 of magnetic body 2 are linear, there are no parts to absorb those differences in expansion/contraction, thus resulting in undulation. However, by forming recessed end sections (e.g., serrations) at edges 16 of magnetic body 2, the differences in expansion/contraction are absorbed by those recessed end sections 13, making it less likely for undulation to occur. In other words, because recessed end sections 13 provide a margin (gap) for expansion/contraction in the sheet face, when differences in expansion/contraction occur, the shapes (areas) of recessed end sections 13 change. Consequently, the expansion/contraction is less likely to exert any influence in the direction of undulation (warping direction), which makes it possible to reduce occurrences of undulation. Undulation (warping) occurs when attempts are made to form magnetic sheet 1 in such a manner as to increase the area of the sheet face and while reducing thickness, as in the ferrite sheet described above.

For such reasons as those above, magnetic sheet 1 of the present embodiment is particularly useful for magnetic sheets 1 having a thickness of 50 μm to 300 μm after firing, and that have a greater sheet face area than a square with sides each measuring 30 mm. By useful, what is meant is that, by means of recessed end sections 13 formed with a lesser depth (W) than the width of the undulation (warping) in magnetic sheet 1 that occurs when no recessed end sections 13 are formed in magnetic sheet 1, undulation is suppressed. A thicker magnetic sheet 1 is less prone to undulation (warping), and differences in expansion/contraction would be better absorbed by the very thickness of magnetic sheet 1. Accordingly, magnetic sheet 1 with a thickness of 300 μm or greater is less likely to suffer undulation, and if it does, the undulation would be strong, and therefore difficult to effectively eliminate by merely forming recessed end sections 13. On the other hand, when the plurality of recessed end sections 13 are formed on magnetic sheet 1 that is 50 μm in thickness or less, the strength of magnetic sheet 1 itself drops. Furthermore, as the sheet face area becomes equal to or greater than a 30 mm×30 mm square, undulation occurs, and as it becomes equal to or greater titan a 40 mm×40 mm square, the width of the region over which undulation is formed as well as the height of undulation increase, making occurrences thereof prominent. Once the sheet face area of magnetic sheet 1 exceeds 100 mm×100 mm, it becomes difficult in some cases to keep the occurrence of undulation under control solely by means of recessed end sections 13. Therefore, it is particularly suitable for magnetic sheets of sizes smaller than the above. Naturally, since undulation (warping) could occur outside of the ranges mentioned above, the claimed invention would still be useful, however, it is particularly effective within those ranges.

On the other hand, increasing the size of recessed end sections 13, particularly depth W (i.e., making recessed end sections 13 at edges 16 of magnetic body 2 recede significantly inward), reduces the effectively usable area of green sheet 12, thereby wasting a portion of green sheet 12. Further, the recessed end sections are weaker than the parts closer to the center of the sheet face (i.e., the parts where no recessed end sections are formed). Consequently, larger recessed end sections 13 render magnetic body 2 more susceptible to damage. Further, because they are of a protruding/recessed shape, damage often originates therefrom. Accordingly, the recessed end sections must be formed as small as possible, but large enough to prevent undulation.

For the present embodiment, green sheet 12 was cut in such a manner as to be 50 mm×70 mm in size, and ten or more recessed end sections 13 of processing (3) (where P=4.10 mm, and W=1.83 mm) per side were formed. While the number of recessed end sections 13 per side may be decided upon as deemed appropriate in accordance with the size in which green sheet 12 is cut and the values of P and W, it is better to provide many.

By thus shaping edges 16 of green sheet 12 so as to be serrated, wave-like, and/or the like, before firing the ferrite, differences in expansion/contraction during ferrite firing may be absorbed. Consequently, occurrences of undulation at edges 16 may be prevented with ease even when magnetic sheet 1 is thin, which enables effective use of the size of green sheet 12, making magnetic sheet 1 easy to use.

As a result, there is no need to eliminate the undulation occurring at edges 16 of magnetic body 2, and the effectively usable area of green sheet 12 increases. Furthermore, no wasteful undulation occurs. Specifically, by forming recessed end sections 13 of a lesser depth (approximately 1 cm or less) than the width of the undulation (approximately 1 cm to 2 cm) that occurs when no recessed end sections 13 are formed, occurrences of undulation in magnetic body 1 may be suppressed. In particular, it is preferable that the plurality of recessed end sections 13 be within the range of 1 mm to 5 mm from the edge of the sheet face of magnetic sheet 1. By so doing, undulation prevention and the securing of strength at the peripheral edges may be attained simultaneously for magnetic sheet 1. Furthermore, while the width of the region where undulation occurs in magnetic sheet 1 is to some extent dependent on the area of the sheet face of magnetic sheet 1, undulation generally tends to concentrate at regions within approximately 1 cm to 2 cm from the edge.

Furthermore, magnetic body 2 would not have to be used with its worsened flatness left as is, which enables even contact with the coil surface to be mounted thereon, as a result of which the performance of the coil may be brought out sufficiently.

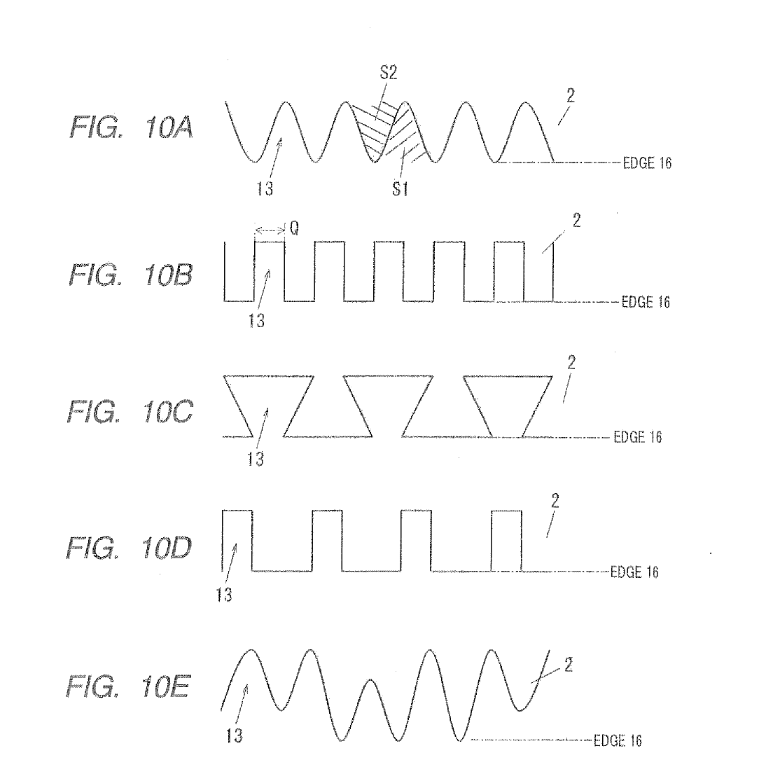

FIGS. 10A through 10E show alternative shapes for recessed end sections 13, FIGS. 10A through 10E are diagrams showing alternative shapes for the recessed end sections at the edges of a magnetic body with respect to the present embodiment.

As shown in FIGS. 10A through 10E, for the pattern of recessed end sections 13, a sinusoidal wave pattern (FIG. 10A), a rectangular wave pattern (FIG. 10B), a wedge-shaped pattern (FIG. 10C), and/or the like, may be applied. The above may also be applied in combination.

Furthermore, when forming recessed end sections 13 in a rectangular wave pattern, the width of recessed end sections 13 may be narrower, as shown in FIG. 10D, as compared to edges 16 in FIGS. 10A through 10C and 10E. Patterns with varying depths of recessed end sections 13 may also be combined as shown in FIG. 10E. However, as indicated in FIG. 8, P and W are set to values equal to or greater than at least those of processing (2).

With respect to the sinusoidal wave pattern in FIG. 10A, for example, S1 denotes the area of each recessed end section 13 at edge 16 (i.e., the portion marked with the right-side-up oblique lines in FIG. 10A), and 82 denotes each area adjacent to S1 of edge 16 (i.e., the portion marked with right-side-down oblique lines in FIG. 10A). Here, undulation prevention effects may be obtained so long as the relationship 0.2≦S1/S2≦1.8 is satisfied. In particular, if 0.8≦S1/S2≦1.2, and more particularly, if S1/S2=1 (i.e., S1=S2), undulation may be prevented, while at the same time the formation of recessed end sections 13 may be carried out with greater ease. Furthermore, the width of the region where recessed end sections 13 are formed may be kept to a minimum, and the region of the sheet face where no recessed end sections 13 are formed may thus be maximized.

When forming recessed end sections 13 having a cyclical pattern, it is preferable that they be formed with a relation similar to the sinusoidal wave pattern described above.

In other words, a greater W value of recessed end sections 13 (see FIG. 8) decreases the effectively usable area of magnetic body 2 while also making damage likelier. Accordingly, the value of W should be kept as small as possible. Without increasing the value of W, by defining the area of recessed end sections 13 through appropriate combinations of P values (see FIG. 8) and Q values (the width of the recessed end sections, see FIG. 8 and FIGS. 10A through 10E), sufficient strength may be ensured for the sheet of magnetic body 2. Furthermore, distortion that tends to occur around the edges during firing may be absorbed, and undulation may thus be prevented. P and Q need not necessarily be equal, but by being comparable to each other, they become better balanced, thus ensuring strength for magnetic sheet 1.

Recessed, end sections 13 are by no means limited to cyclical recessed sections having a given pitch. However, being cyclical simplifies the tool/die and their forming process. Furthermore, recessed end sections 13 need not be of triangular shapes formed of straight lines, and may instead be curved. However, it is easier to make tools/dies and/or the like if they are triangular.

A magnetic sheet of the present embodiment may also be used in, for example, wireless (contactless) charging system modules for mobile terminals and electronic devices (e.g., mobile phones, digital cameras, laptop PCs, etc.) that are equipped with an antenna apparatus and a wireless charging module. Because wireless charging modules are charged through electromagnetic induction, they include a coil, and magnetic sheet 1 that improves the power transfer efficiency of this coil. Magnetic sheets 1 used in wireless charging modules are relatively thick, and generally measure 300 μm to 1 mm. Omnidirectional flexibility is also demanded for magnetic sheets 1 provided in wireless charging modules. Being equipped with magnetic sheet 1 of the present embodiment provides omnidirectional flexibility. Thickness reduction can also be achieved with ease.

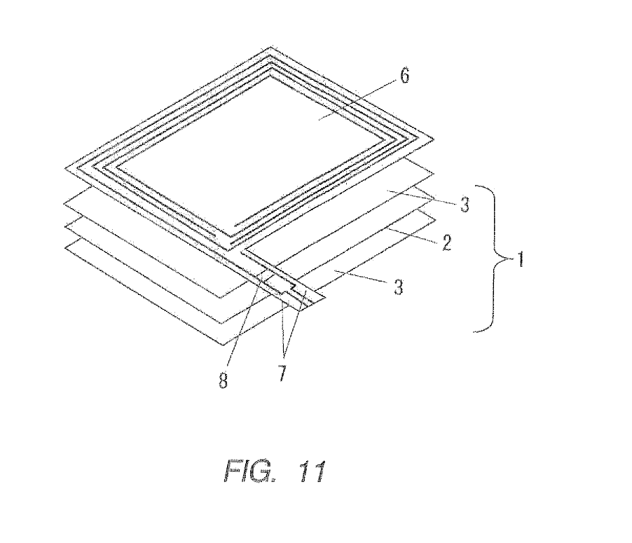

FIG. 11 is a configuration diagram of an antenna apparatus with respect to the present embodiment.

For antenna 6, a loop antenna is formed in a spiral manner. A spiral structure need only be of a spiral shape having an opening in the center, where its shape may be circular, generally rectangular, or polygonal. By adopting a spiral structure, a sufficient magnetic field is obtained, and communications between a wireless communication medium and a wireless communication medium processing apparatus are made possible through the generation of induced power and mutual inductance. The substrate on which antenna 6 is provided may be formed of a polyimide, FET, or glass epoxy substrate and/or the like.

Furthermore, as deemed appropriate, the material of the antenna may be selected from conductive metal wire materials, metal plate materials, metal foil materials, metal cylinder materials, and/or the like, made of gold, silver, copper, aluminum, nickel, and/or the like. The antenna may be formed with a metal wire, a metal foil, a conductive paste, through plating transfer, sputtering, vapor deposition, or screen printing.

Sheet-shaped magnetic body 2 both of whose upper and lower faces are coated with protective members 3 has extremely good flexibility. Accordingly, it can be punch mold processed with ease through punching, and/or the like, and is therefore characteristic in that it can be molded cheaply and in large quantities even when processing of complex shapes is involved.

Protective member 3 may be a resin, an ultraviolet curing resin, a visible light curing resin, a thermoplastic resin, a thermosetting resin, a heat resistant resin, synthetic rubber, a double-sided tape, an adhesive layer, a film, and/or the like. The selection may be made by taking into account not just flexibility for accommodating any bending, deflection, and/or the like, of an antenna apparatus and the various components forming the antenna apparatus, but also on weather resistance, e.g., heat resistance, moisture resistance, and/or the like.

Terminal connection section 7 is formed on the outer side of antenna 6, and is connected to both end sections of antenna 6. Terminal connection section 7 may also be formed on the substrate on which antenna 6 is provided. Terminal connection section 7 is connected to a connector on a circuit board of a portable terminal, e.g., a mobile phone, and/or the like. Chip capacitor 8 is mounted on the substrate in proximity to terminal connection section 7, which is an end of antenna 6, antenna 6 being a loop antenna. By varying the capacitance of chip capacitor 8, the resonance point of the resonance frequency of the antenna apparatus may be varied. In order to mount this antenna apparatus on a small terminal, e.g., a mobile phone, and/or the like, the substrate on which antenna 6 is formed has a double-sided tape, an adhesive, an adhesive layer, a resin, and/or the like applied thereto and is stuck at its designated location in the mobile terminal.

A magnetic sheet of the present embodiment may also be used in, for example, wireless (contactless) charging system modules for mobile terminals and electronic devices (e.g., mobile phones, digital cameras, laptop PCs, etc.). Because wireless charging modules are charged through electromagnetic induction, they include a coil, and magnetic sheet 1 that improves the power transfer efficiency of this coil. Magnetic sheets 1 used in wireless charging modules are relatively thick, and generally measure 300 μm to 1 mm. Omnidirectional flexibility is also demanded for magnetic sheets 1 provided in wireless charging modules. Being equipped with magnetic sheet 1 of the present embodiment provides omnidirectional flexibility. Thickness reduction can also be achieved with ease.

### INDUSTRIAL APPLICABILITY

The claimed invention is useful for mobile terminals equipped with an antenna apparatus and/or a wireless charging module including a thin magnetic sheet, and particularly for various electronic devices such as mobile phones, portable audio devices, personal computers, digital cameras, video cameras, and/or the like.

1. A magnetic sheet, comprising:
a magnetic body;
a protective member provided on at least one face of the magnetic body; and
a plurality of holes provided in at least one face of the magnetic body, wherein the magnetic body is divided into a plurality of fragments using the plurality of holes, and the plurality of fragments vary in shape.

2. The magnetic sheet according to claim 1, wherein, with respect to the plurality of holes, the magnetic body is divided at least between holes that are closest to one another.

3. The magnetic sheet according to claim 1, wherein the plurality of holes are each adjacent to at least three other holes by a shortest distance.

4. The magnetic sheet according to claim 1, wherein the plurality of holes are each adjacent to four other holes by a shortest distance and are arranged in a grid-like fashion.

5. The magnetic sheet according to claim 1, wherein the plurality of holes are each of a tapered shape so that the area of a top section is greater than the area of a bottom section.

6. The magnetic sheet according to claim 1, wherein a bottom of each of the holes is polygonal, and the magnetic body is divided using corners of the bottoms of the plurality of holes.

7. The magnetic sheet according to claim 1, frirther comprising a plurality of recessed end sections provided at edges of a sheet face of the magnetic body, the plurality of recessed end sections receding inward of the sheet face from the edges of the sheet face.

8. The magnetic sheet according to claim 7, wherein the thickness of the magnetic sheet falls within the range of 50 μm to 300 μm.

9. The magnetic sheet according to claim 7, wherein the sheet face is larger than a square having sides each measuring 30 mm.

10. The magnetic sheet according to claim 7, wherein the plurality of recessed end sections are within 1 mm to 1 cm from the edges of the sheet face.

11. The magnetic sheet according to claim 1, wherein the magnetic sheet comprises a fired ferrite sheet.

12. An antenna apparatus comprising the magnetic sheet according to claim 1.

13. A method of producing a magnetic sheet including ferrite as a material, the method comprising:
forming a plurality of holes in a sheet face of the magnetic sheet;
firing the magnetic sheet; and
dividing the magnetic sheet into a plurality of fragments using the plurality of holes, wherein
the divided plurality of fragments vary in shape.

14. The method according to claim 13, wherein, in firing the magnetic sheet, a plurality of recessed end sections are formed at edges of the sheet face of the magnetic sheet, the plurality of recessed end sections receding inward of the sheet face from the edges of the sheet face.
